(19) United States
(12) Patent Application Publication
(10) Pub. No.: US 2024/0109699 A1
(43) Pub. Date: Apr. 4, 2024

(54) CASE WITH BATTERY CONSERVATION FUNCTIONALITY

(71) Applicant: Starkey Laboratories, Inc., Eden Prairie, MN (US)

(72) Inventors: Sidney A. Higgins, Maple Grove, MN (US); Denise Klokow, Faribault, MN (US); Chris Howes, Eden Prairie, MN (US)

(21) Appl. No.: 18/376,190

(22) Filed: Oct. 3, 2023

Related U.S. Application Data
(60) Provisional application No. 63/412,750, filed on Oct. 3, 2022.

(51) Int. Cl. B65D 51/26; B65D 25/10; B65D 43/02; B65D 43/16

(52) U.S. Cl. CPC B65D 51/26; B65D 25/10; B65D 43/0225; B65D 43/163; B65D 2543/00092; B65D 2543/00194

(57) ABSTRACT

Embodiments herein relate to cases such as battery cases and wearable device cases that can be used to prolong the life of batteries used for powering wearable devices. In a first aspect, a case can be included having a base portion defining one or more battery wells and a lid portion including one or more battery well plugs. The lid portion moves between a closed position wherein it can be engaged with the base portion and an open position wherein it can be disengaged from the base portion to allow access to contents therein. The one or more battery well plugs engage with the one or more battery wells when the lid is in the closed position to prevent the flow of oxygen into a battery within the battery well thereby slowing or ceasing the oxidation reaction of the battery and preserving battery life. Other embodiments are also included herein.

This application claims the benefit of U.S. Provisional Application No. 63/412,750, filed Oct. 3, 2022, the content of which is herein incorporated by reference in its entirety.

### FIELD

Embodiments herein relate to devices such as cases that can be used to prolong the life of batteries used for powering wearable devices.

### BACKGROUND

Hearing assistance devices can provide tremendous benefit to those with some degree of hearing loss or perceived hearing difficulty. Modern hearing assistance devices are extremely powerful and have many capabilities.

Hearing assistance devices are typically powered with batteries. Batteries can be of various types. However, one common type for heating assistance devices are metal-air batteries. Metal-air batteries, such as zinc-air batteries, have an anode made from a metal and during discharging the metal anode is oxidized using oxygen typically from the ambient environment. Typically, metal-air batteries are supplied with a tab or sticker that is removed to activate the battery and start the oxidation reaction and the generation of electrical current. While metal-air batteries are inexpensive and offer relatively high energy density, after activation the chemical reactions therein generally continue whether the battery is under load or not and therefore, they typically do not have a long life after they are activated.

### SUMMARY

Embodiments herein relate to devices such as cases, including ear-wearable device cases and battery case, that can be used to prolong the life of batteries used for powering wearable devices. In a first aspect, a wearable device case can be included having a base portion defining one or more battery wells and a lid portion including one or more battery well plugs. The lid portion moves between a closed position wherein it can be engaged with the base portion and an open position wherein it can be disengaged from the base portion to allow access to contents therein. The one or more battery well plugs engage with the one or more battery wells when the lid is in the closed position to prevent the flow of oxygen into a battery within the battery well thereby slowing or ceasing the oxidation reaction of the battery and preserving battery life.

In a second aspect, in addition to one or more of the preceding or following aspects, or in the alternative to some aspects, the case can include a hinge mechanism connecting the base portion with the lid portion and facilitating movement of the lid portion between an open position and a close position.

In a third aspect, in addition to one or more of the preceding or following aspects, or in the alternative to some aspects, the lid portion screws down onto the base portion instead of simply swinging closed.

In a fourth aspect, in addition to one or more of the preceding or following aspects, or in the alternative to some aspects, the one or more battery well plugs can include a deformable tip.

In a fifth aspect, in addition to one or more of the preceding or following aspects, or in the alternative to some aspects, the deformable tip can include an elastomeric material.

In a sixth aspect, in addition to one or more of the preceding or following aspects, or in the alternative to some aspects, the elastomeric material can have a Shore A durometer value of 10 to 90.

In a seventh aspect, in addition to one or more of the preceding or following aspects, or in the alternative to some aspects, the base portion can define a basin that is configured to receive a hearing assistance device.

In an eighth aspect, in addition to one or more of the preceding or following aspects, or in the alternative to some aspects, the base portion can include from two to ten battery wells and the lid portion can include from two to ten battery well plugs.

In a ninth aspect, in addition to one or more of the preceding or following aspects, or in the alternative to some aspects, the one or more battery wells can define an access slot. The access slot can be disposed along a side of the one or more battery wells.

In a tenth aspect, in addition to one or more of the preceding or following aspects, or in the alternative to some aspects, the base portion can include a shell and an insert.

In an eleventh aspect, a wearable device case can be included having a base portion defining a device storage area and a lid portion. The lid portion can include one or more battery compartment plugs. The lid portion can move between a closed position wherein it can be fully engaged with the base portion and an open position wherein it can be disengaged from the base portion to allow access to contents therein. The one or more battery compartment plugs can seal a battery compartment on a hearing assistance device when the lid can be in the closed position.

In a twelfth aspect, in addition to one or more of the preceding or following aspects, or in the alternative to some aspects, the case can further include a hinge mechanism, wherein the hinge mechanism connects the base portion with the lid portion.

In a thirteenth aspect, in addition to one or more of the preceding or following aspects, or in the alternative to some aspects, the lid portion screws down onto the base portion.

In a fourteenth aspect, in addition to one or more of the preceding or following aspects, or in the alternative to some aspects, the one or more battery compartment plugs can include a deformable tip.

In a fifteenth aspect, in addition to one or more of the preceding or following aspects, or in the alternative to some aspects, the deformable tip can include an elastomeric material.

In a sixteenth aspect, in addition to one or more of the preceding or following aspects, or in the alternative to some aspects, the elastomeric material can have a Shore A durometer value of 10 to 90.

In a seventeenth aspect, in addition to one or more of the preceding or following aspects, or in the alternative to some aspects, the base portion can define a basin, wherein the basin can be configured to receive a hearing assistance device.

In an eighteenth aspect, in addition to one or more of the preceding or following aspects, or in the alternative to some aspects, the base portion can include from two to ten battery wells and the lid portion further can include from two to ten battery well plugs.

In a nineteenth aspect, a method of extending the life of metal-air batteries for use with a wearable device can be included. The method can include placing an activated metal-air battery within a battery well of a case for a wearable device and closing the case causing a battery plug to engage with the battery well and the metal-air battery therein.

In a twentieth aspect, in addition to one or more of the preceding or following aspects, or in the alternative to some aspects, the case can include a base portion and a lid portion. Closing the case can cause the lid portion to engage the base portion moving the battery plug into position with the battery well.

In a twenty-first aspect, a battery case can be included having a base portion. The base portion can include one or more battery wells. The one or more battery wells can define an access slot. The access slot can be disposed along a side of the one or more battery wells. The battery case can also include a lid portion. The lid portion can move between a closed position wherein it can be engaged with the base portion and an open position wherein it can be disengaged from the base portion to allow access to contents therein.

In a twenty-second aspect, in addition to one or more of the preceding or following aspects, or in the alternative to some aspects, the lid portion screws down onto the base portion.

In a twenty-third aspect, in addition to one or more of the preceding or following aspects, or in the alternative to some aspects, the lid portion fits onto the base portion with a friction-fit mechanism.

In a twenty-fourth aspect, in addition to one or more of the preceding or following aspects, or in the alternative to some aspects, the base portion further can include from two to ten battery wells.

In a twenty-fifth aspect, in addition to one or more of the preceding or following aspects, or in the alternative to some aspects, the base portion further can include a clip.

In a twenty-sixth aspect, in addition to one or more of the preceding or following aspects, or in the alternative to some aspects, further can include one or more battery plugs, wherein the one or more battery plugs can be disposed within the one or more battery wells.

In a twenty-seventh aspect, in addition to one or more of the preceding or following aspects, or in the alternative to some aspects, the one or more battery wells can be arranged in a circular pattern.

In a twenty-eighth aspect, in addition to one or more of the preceding or following aspects, or in the alternative to some aspects, the access slots can be disposed facing radially outward from the circular pattern of battery wells.

In a twenty-ninth aspect, in addition to one or more of the preceding or following aspects, or in the alternative to some aspects, the lid portion can be configured to engage with batteries in the one or more battery wells when the lid is in a closed position.

In a thirtieth aspect, in addition to one or more of the preceding or following aspects, or in the alternative to some aspects, the case can further include a cleaning tool, wherein the cleaning tool can be mounted on a surface of the battery case.

In a thirty-first aspect, in addition to one or more of the preceding or following aspects, or in the alternative to some aspects, the cleaning tool can include at least one selected from the group consisting of a brush and a pick.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following figures (FIGS.), in which:

FIG. 1 is a perspective view of a wearable device in accordance with various embodiments herein.

FIG. 2 is a perspective view of a battery in accordance with various embodiments herein.

FIG. 3 is a perspective view of a wearable device case in accordance with various embodiments herein.

FIG. 4 is a cross-sectional view of the wearable device case as taken along line 4-4′ of FIG. 3.

FIG. 5 is a schematic cross-sectional view of a battery plug interfacing with a device housing in accordance with various embodiments herein.

FIG. 6 is an exploded perspective view of a battery case in accordance with various embodiments herein.

FIG. 7 is a top perspective view of batteries in a battery case in accordance with various embodiments herein.

FIG. 8 is a perspective view of a battery case in accordance with various embodiments herein.

FIG. 9 is a perspective view of a battery case in accordance with various embodiments herein.

While embodiments are susceptible to various modifications and alternative forms, specifics thereof have been shown by way of example and drawings, and will be described in detail. It should be understood, however, that the scope herein is not limited to the particular aspects described. On the contrary, the intention is to cover modifications, equivalents, and alternatives falling within the spirit and scope herein.

### DETAILED DESCRIPTION

As referenced above, metal-air batteries are inexpensive and offer relatively high energy density. However, after activation the chemical reactions therein generally continue whether the battery is under load or not. Therefore, they typically have only a short life after they are activated.

However, embodiments herein relate to battery cases and wearable device cases that can be used to prolong the life of metal-air batteries. In various embodiments, a case herein can include a battery plug that engages with a battery when the case is closed to prevent the flow of oxygen into the battery thereby slowing or ceasing the oxidation reaction and preserving battery life. For example, in an embodiment, a wearable device case is included having a base portion defining one or more battery wells and a lid portion comprising one or more battery well plugs. The lid portion can move between a closed position where it is engaged with the base portion and an open position wherein it is disengaged from the base portion to allow access to contents therein. The one or more battery well plugs can engage with the one or more battery wells and/or batteries therein when the lid is in the closed position to limit or block the flow of oxygen into the battery to slow or cease the oxidation reaction therein.

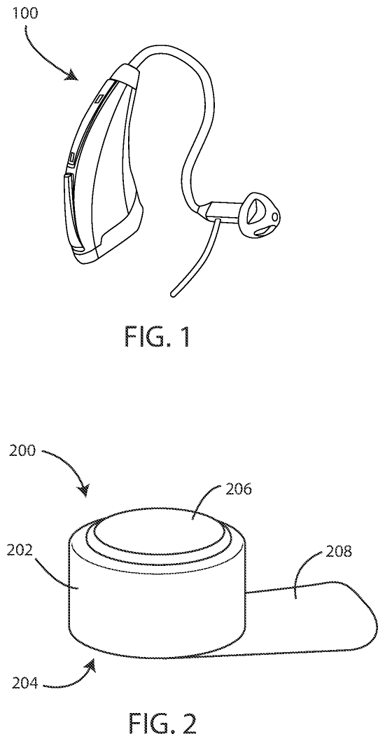

Referring now to FIG. 1, a perspective view of a wearable device 100 is shown in accordance with various embodiments herein. In this particular example, the wearable device 100 is a hearing assistance device. However, other wearable devices are also contemplated herein. It will be appreciated that hearing assistance devices can come in many different forms. By way of example, hearing assistance devices herein can include, but are not limited to, behind-the-ear (BTE), in-the ear (ITE), in-the-canal (ITC), invisible-in-canal (IIC), receiver-in-canal (RIC), receiver in-the-ear (RITE) and completely-in-the-canal (CIC) type hearing assistance devices, amongst other types.

Referring now to FIG. 2, a perspective view of a battery is shown in accordance with various embodiments herein. FIG. 2 shows a metal-air battery 200. The metal-air battery 200 includes a housing 202. The metal-air battery 200 also includes a bottom surface 204. The metal-air battery 200 also includes an electrode 206. The metal-air battery 200 also includes an activation tab 208. When the activation tab 208 is removed, an aperture within the bottom surface 204 is exposed allowing the flow of air (carrying oxygen) into the battery housing 202 which allows an oxidation reaction to take place. Metal-air batteries herein can include iron-air, lithium-air, zinc-air, sodium-air, magnesium-air, and the like. In various embodiments herein, the metal-air battery is a zinc-air battery. The size of the battery is not particularly limited. However, in some embodiments, the battery can be a size 10, 312, 13, 675, or the like.

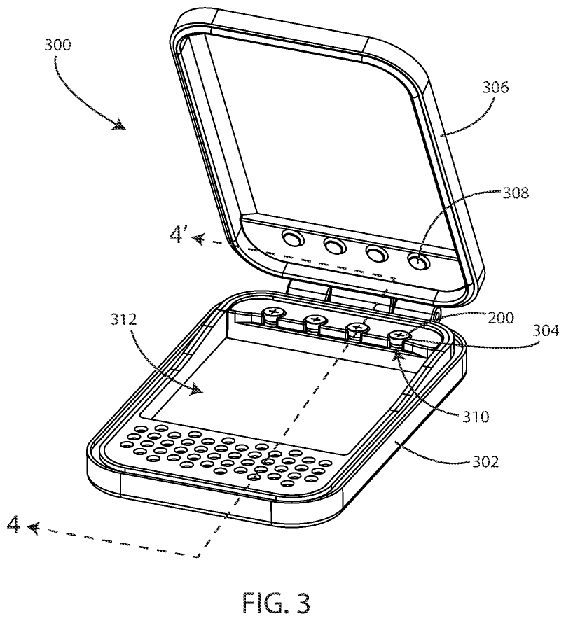

Referring now to FIG. 3, a perspective view of a wearable device case 300 is shown in accordance with various embodiments herein. The wearable device case 300 includes a base portion 302. The base portion 302 includes one or more battery wells 304. The base portion 302 also includes a basin 312. The basin 312 can serve as a wearable device storage area. The wearable device case 300 also includes a lid portion 306. The lid portion 306 includes a one or more battery compartment plugs 308.

In various embodiments, the lid portion 306 moves between a closed position wherein it is engaged with a base portion 302 and an open position wherein it is disengaged from the base portion 302 to allow user access to contents therein. In various embodiments, the battery plugs 308 engage with the one or more battery wells 304 when the lid 306 is in the closed position. The battery plugs 308 can also engage with batteries 200 in the one or more battery wells 304 when the lid 306 is in the closed position. In this position, the battery plugs 308 can block and/or inhibit the exchange of air from the ambient environment with the inside of the batteries thereby slowing or ceasing the oxidation reaction inside the metal-air battery and preserving the same.

In some embodiments, the battery wells 304 can define an access slot 310 to make it easier to retrieve batteries from the battery wells 304. In various embodiments, the access slot 310 can be disposed along a side of one or more of the battery wells. The access slot 310 can extend from a top of a side wall of the battery wells 304 part way or all of the way down to the bottom of the battery wells 304.

The battery plugs 308 as shown in FIG. 3 are approximately circular in cross-section but can take on various other shapes such as oval, square, irregular, or the like. In some embodiments, the battery plugs 308 are approximately cylindrical, conical, frustoconical, or the like in shape. In various embodiments, the battery plugs 308 can be shaped and configured to mate with the battery wells 304. The battery wells 304 can be circular in cross-section so as to receive batteries that are circular in cross-section. However, battery wells 304 can also take on various other shapes. The battery wells 304 can be appropriately size to receive a metal-air battery. For example, the battery wells 304 can be sized to receive batteries of size 10, 312, 13, 675, or the like.

In various embodiments, the base portion 302 can define a basin 312. The basin 312 can be configured to receive a hearing assistance device or other wearable device therein. In some embodiments, the basin 312 can be contoured to precisely fit a wearable device.

The number of battery wells is not particularly limited. There can be one, two, three, four, or more battery wells, or from two to ten battery wells in some embodiments. Similarly, the number of battery plugs is not particularly limited. In some cases, there can be a battery plug for each battery well. In some embodiments there can be one, two, three, four or more battery wells, or from two to ten battery plugs.

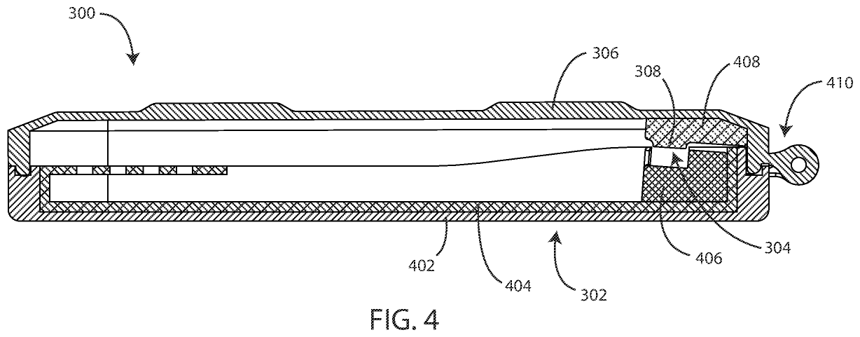

Referring now to FIG. 4, a cross-sectional view of the wearable device case 300 is shown as taken along line 4-4′ of FIG. 3. The wearable device case 300 includes a base portion 302. The wearable device case 300 also includes a lid portion 306. The wearable device case 300 can include a hinge mechanism 410. In various embodiments, the hinge mechanism 410 connects the base portion 302 with the lid portion 306 and allows the lid portion 306 to swing between an open position and a closed position. In some embodiments, other mechanisms can be used to provide a connection between the lid portion 306 and the base portion 302.

The base portion 302 can define one or more battery wells 304. In some embodiments, the base portion 302 can be a single piece of material, but in other embodiments it can include multiple discrete pieces of material. In some embodiments, the base portion 302 includes a shell 402 and a first insert 404 therein. In some embodiments, the base portion 302 also includes a second insert 406. The base portion 302 and portions thereof can be formed of various materials. In some embodiments, the base portion 302 and/or portions thereof can be formed with a metal, a polymer, a composite, or the like. In some embodiments, the base portion 302 and/or portions thereof can be formed with an injection moldable polymer.

The lid portion 306 includes a one or more battery compartment plugs 308. In some embodiments, the lid portion 306 can be a single piece of material, but in other embodiments it can include multiple discrete pieces of material. In some embodiments, the lid portion 306 includes a top insert 408. The lid portion 306 and portions thereof can be formed of various materials. In some embodiments, the lid portion 306 and/or portions thereof can be formed with a metal, a polymer, a composite, or the like. In some embodiments, the lid portion 306 and/or portions thereof can be formed with an injection moldable polymer.

Battery well plugs herein can take on various forms and can be made of various materials. In various embodiments, the battery well plugs can include a deformable tip. The deformable tip can allow for a better seal to be formed and therefore more effective blocking of the exchange of air with the battery.

In various embodiments, the battery well plug and/or the deformable tip thereof can be formed of an elastomeric material, such as an elastomeric polymeric material. In various embodiments, the elastomeric material has a Shore A durometer value of 10 to 90.

In the embodiments illustrated with respect to FIGS. 3-4, the battery to be preserved is placed in a battery well and then when the case is closed a battery plug interfaces with the battery well and/or the battery itself. However, in some embodiments, the case herein can be configured so that a battery plug interfaces with a battery that is already installed in a wearable device (e.g., without the need to remove the battery and place it in a battery well). For example, a battery plug may interface with a housing for a wearable device within the case and/or with an aperture defined by the same when the cover is closed to slow or cease the oxidation reaction for a battery that is already installed within the wearable device. In this manner, batteries can be preserved without being removed from the wearable device.

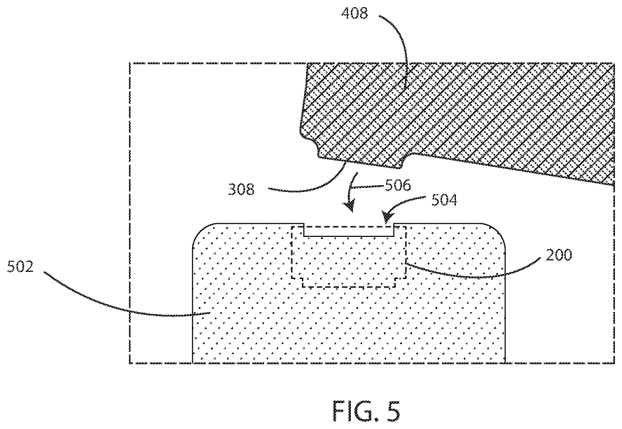

Referring now to FIG. 5, a schematic cross-sectional view of a battery plug interfacing with a device housing 502 of a wearable device is shown in accordance with various embodiments herein. A base portion (not shown in this view) of a case can define a device storage area that can receive a wearable device herein and hold it in a specific position. The device housing 502 includes a battery access aperture 504. A metal-air battery 200 may be disposed within the wearable device and reached through the battery access aperture 504. A lid portion of a case can include one or more battery compartment plugs 308. When the lid closes, the battery compartment plugs 308 move in the direction of arrow 506 such that the plugs interface with the battery access aperture 504 and the metal-air battery 200 therein to block the passage of air into and out of the battery 200.

The case shown in FIGS. 3-4 illustrates a clam shell type design with the lid swinging around a hinge to interface with the base portion. However, it will be appreciated that lids and bases can interface with respect to one another in various other ways. For example, in some embodiments, the lid portion 306 can screw down onto the base portion 302. In some embodiments, the lid portion 306 can be pushed onto the base portion 302 and retained via friction or a snap-fit mechanism.

Embodiments herein can also include cases that are configured to hold and preserve batteries in the absence of holding wearable devices. For example, stand-alone battery cases for preserving batteries are also included herein.

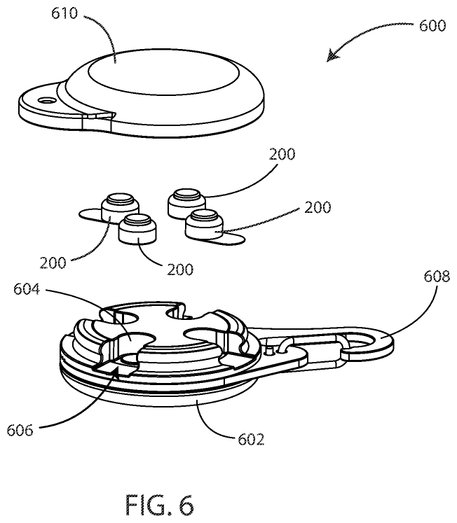

Referring now to FIG. 6, an exploded perspective view is shown of a battery case 600 in accordance with various embodiments herein. The battery case 600 includes a base portion 602. The base portion 602 can include one or more battery wells 604 optionally along with access slot 606. In some embodiments, the battery case 600 can also include a clip 608, such as a lanyard clip or a carabiner clip. However, the clip 608 can be omitted in various embodiments. The batteries 200 can fit within the battery wells 604 and can be pressed against the bottom of the battery well 604 thereby ceasing or reducing the flow of oxygen into the battery and slowing or stopping the oxidation reaction thus preserving the batteries. In some embodiments, a battery plug can be disposed at the bottom of the battery wells and the battery plug can engage with the batteries. In some embodiments, a battery plug can be disposed on the cap portion 610 and can engage with the batteries. However, in some embodiments a battery plug can be omitted. The battery wells 604 can be arranged in a circular pattern. The access slots 606 can be disposed facing radially outward from the battery wells 604 in the circular pattern. However, the battery wells 604 can also be arranged according to other patterns.

A cap portion 610 can fit on top of the base portion 602 and be configured to retain the batteries 200 within the battery wells 604. The access slots 606 can allow for a battery activation tab to stick out therefrom and/or can allow for a place to contact the batteries from the side to aid in lifting them out of the battery wells 604. In some embodiments, the cap portion 610 can include threads matching threads on the base portion 602 and can screw down onto the base portion 602. In some embodiments, the cap portion 610 can be pressed onto the base portion 602 and be retained using a friction fit or snap-fit mechanism. Various other structures and techniques for retaining the cap portion 610 onto the base portion 602 are also contemplated herein.

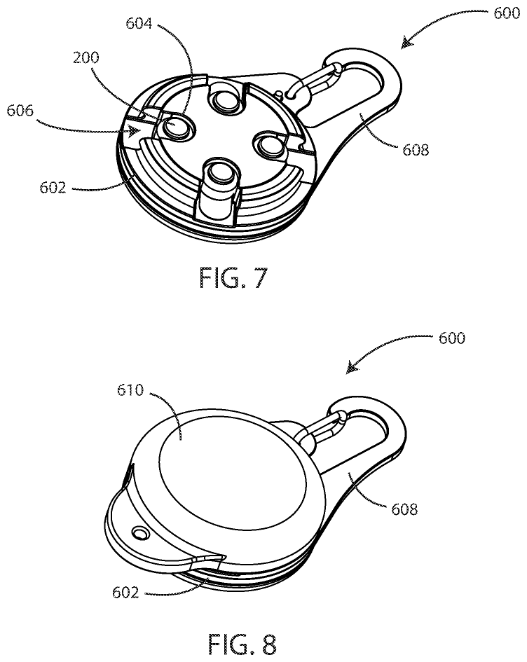

Referring now to FIG. 7, a top perspective view is shown of batteries 200 in a battery case 600 in accordance with various embodiments herein. In this view, the batteries 200 are within the battery wells 604. Those batteries with tabs can fit within battery well 604 with the battery tab sticking out of the access slot 606.

Referring now to FIG. 8, a perspective view is shown of a battery case 600 in accordance with various embodiments herein. In this view, the cap portion 610 has been put onto the base portion 602 thereby pressing the batteries into the battery wells and preserving the batteries (not shown in this view) by stopping or slowing the oxidation reaction.

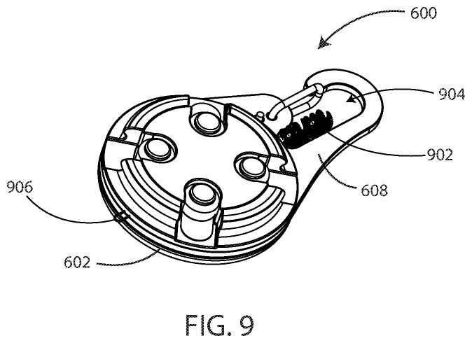

In some embodiments, cases herein can include one or more tools, such as cleaning tools. The cleaning tools can be useful for cleaning of a wearable device amongst other things. Referring now to FIG. 9, a perspective view is shown of a battery case 600 in accordance with various embodiments herein. As before, the battery case 600 includes base portion 602 and clip 608. In this example, the battery case 600 can also include a first tool 902, such as a brush, and a second tool 906, such as a pick. In some embodiments, at least one of the tools, such as the first tool 902 can be disposed within an enclosed open portion of the clip 608. However, the tools can be mounted (fixed or detachably mounted) at any place along the surface of the battery case 600 or components thereof.

### Methods

Many different methods are contemplated herein, including, but not limited to, methods of making, methods of using, and the like. Aspects of system/device operation described elsewhere herein can be performed as operations of one or more methods in accordance with various embodiments herein.

In an embodiment, a method of extending the life of metal-air batteries for use with a wearable device is included. The method can include operations of placing an activated metal-air battery within a battery well of a battery case and/or a case for a wearable device. The method can also include closing the case. In some embodiments, closing the case can cause a battery plug to engage with the battery well and the metal-air battery therein. In some embodiments, closing the case can cause the battery to engage the bottom of the battery well and cease or slow the oxidation reaction. In an embodiment, the case can include a base portion and a lid portion and closing the case can cause the lid portion to engage the base portion moving the battery plug into position with the battery well.

It should be noted that, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

As used herein, the recitation of numerical ranges by endpoints shall include all numbers subsumed within that range (e.g., 2 to 8 includes 2.1, 2.8, 5.3, 7, etc.).

The headings used herein are provided for consistency with suggestions under 37 CFR 1.77 or otherwise to provide organizational cues. These headings shall not be viewed to limit or characterize the invention(s) set out in any claims that may issue from this disclosure. As an example, although the headings refer to a “Field,” such claims should not be limited by the language chosen under this heading to describe the so-called technical field. Further, a description of a technology in the “Background” is not an admission that technology is prior art to any invention(s) in this disclosure. Neither is the “Summary” to be considered as a characterization of the invention(s) set forth in issued claims.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

1. A wearable device case comprising:
a base portion, the base portion defining one or more battery wells;
a lid portion, the lid portion comprising one or more battery well plugs;
wherein the lid portion moves between a closed position wherein it is engaged with the base portion and an open position wherein it is disengaged from the base portion to allow access to contents therein; and
wherein the one or more battery well plugs engage with the one or more battery wells when the lid is in the closed position.

2. The wearable device case of claim 1, further comprising a hinge mechanism, wherein the hinge mechanism connects the base portion with the lid portion.

3. The wearable device case of claim 1, wherein the lid portion screws down onto the base portion.

4. The wearable device case of claim 1, the one or more battery well plugs comprising a deformable tip.

5. The wearable device case of claim 4, the deformable tip comprising an elastomeric material.

6. The wearable device case of claim 5, wherein the elastomeric material has a Shore (Original) A durometer value of 10 to 90.

7. The wearable device case of claim 1, the base portion defining a basin, wherein the basin is configured to receive a hearing assistance device.

8. The wearable device case of claim 1, the base portion comprising:
defining from two to ten battery wells; and
the lid portion further comprising from two to ten battery well plugs.

9. The wearable device case of claim 1, the one or more battery wells defining an access slot, wherein the access slot is disposed along a side of the one or more battery wells.

10. The wearable device case of claim 1, the base portion comprising:
a shell; and
an insert.

11. A wearable device case comprising:
a base portion, the base portion defining a device storage area;
a lid portion, the lid portion comprising one or more battery compartment plugs;
wherein the lid portion moves between a closed position wherein it is fully engaged with the base portion and an open position wherein it is disengaged from the base portion to allow access to contents therein; and
wherein the one or more battery compartment plugs seal a battery compartment on a hearing assistance device when the lid is in the closed position.

12. The wearable device case of claim 11, further comprising a hinge mechanism, wherein the hinge mechanism connects the base portion with the lid portion.

13. The wearable device case of claim 11, wherein the lid portion screws down onto the base portion.

14. The wearable device case of claim 11, the one or more battery compartment plugs comprising a deformable tip.

15. The wearable device case of claim 14, the deformable tip comprising an elastomeric material.

16. The wearable device case of claim 15, wherein the elastomeric material has a Shore (Original) A durometer value of 10 to 90.

17. The wearable device case of claim 11, the base portion defining a basin, wherein the basin is configured to receive a hearing assistance device.

18. The wearable device case of claim 11, the base portion comprising:
defining from two to ten battery wells; and
the lid portion further comprising from two to ten battery well plugs.

19-20. (canceled)

21. A battery case comprising:
a base portion, the base portion comprising
one or more battery wells, the one or more battery wells defining an access slot, wherein the access slot is disposed along a side of the one or more battery wells; and
a lid portion, wherein the lid portion moves between a closed position wherein it is engaged with the base portion and an open position wherein it is disengaged from the base portion to allow access to contents therein.

22-26. (canceled)

27. The battery case of claim 21, wherein the one or more battery wells arranged in a circular pattern, wherein the access slots are disposed facing radially outward from the circular pattern of battery wells.

28-31. (canceled)
